(19) United States
(12) Patent Application Publication
(10) Pub. No.: US 2023/0380947 A1
(43) Pub. Date: Nov. 30, 2023

(54) ELECTRIC TOOTHBRUSH AND CONTROL METHOD THEREOF

(71) Applicant: ZHUHAI QUYIN TECHNOLOGY CO., LTD., Zhuhai (CN)

(72) Inventor: Xuexue JIAN, Zhuhai (CN)

(21) Appl. No.: 17/858,978

(22) Filed: Jul. 6, 2022

(30) Foreign Application Priority Data
May 24, 2022 (CN) 202210578077.1

(51) Int. Cl. A61C 17/22; A46B 9/04; A46B 13/02; A46B 15/00; A46B 5/00

(52) U.S. Cl. CPC A61C 17/221; A46B 9/04; A46B 13/02; A46B 15/0006; A46B 15/0012; A46B 15/0044; A46B 15/004; A46B 5/00

(57) ABSTRACT

An electric toothbrush and a control method thereof includes a brush head, a brush handle, a motor, a pressure responding unit, and a control unit. The motor is disposed in the brush handle, a driving shaft of the motor penetrates through the brush handle and is connected with the brush head for driving. The pressure responding unit is disposed in the brush handle, and the pressure responding unit is configured to acquire a force of the brush head. The control unit is disposed in the brush handle, and the control unit is electrically connected with the pressure responding unit and the motor.

### TECHNICAL FIELD

The present disclosure relates to a technical field of electronics, and in particular to an electric toothbrush and a control method thereof.

### BACKGROUND

Nowadays, electric toothbrushes become more and more popular in human life. With promotion of market, conventional toothbrushes can no longer meet needs of people. People hope that the toothbrushes may become more and more intelligent and provide better services for teeth. The electric toothbrushes rapidly rotate or vibrate through a power output shaft of a motor, thereby driving brush heads to generate high-frequency vibration, instantly decomposing toothpaste into fine foam, and deeply cleaning the teeth. Meanwhile, vibration of bristles promotes blood circulation of oral cavities of people, which has a massage effect on gum tissues.

During use of the electric toothbrushes, a user holds an electric toothbrush handle and extends the brush head into the oral cavity, so that the bristles are in contact with the teeth for cleaning. However, in the use of the electric toothbrushes, brushing is carried out according to manually control of the user, and the brushing cannot be controlled independently and intelligently. When the user uses the electric toothbrushes, turning on the electric toothbrushes causes the toothpaste and the foam to splash. When the user uses the electric toothbrushes with too much force, surfaces of gums or the teeth are easily damaged.

### SUMMARY

Embodiments of the present disclosure provide an electric toothbrush and a control method thereof, which improves intelligence of the electric toothbrush and meets requirements of users.

The embodiments of the present disclosure provide the electric toothbrush, including a brush head, a brush handle, a motor, a pressure responding unit, and a control unit. The motor is disposed in the brush handle. A driving shaft of the motor penetrates through the brush handle and is electrically connected with the brush head for driving. The pressure responding unit is disposed in the brush handle, and the pressure responding unit is configured to acquire a force of the brush head. The control unit is disposed in the brush handle, and the control unit is electrically connected with the pressure responding unit and the motor. The control unit is configured as follows.

When the force is less than a first threshold, the control unit controls the motor to work at a first working frequency.

When the force is greater than the first threshold but less than a second threshold, the control unit increases the working frequency of the motor to control the motor to work at a second working frequency, the first threshold is less than the second threshold, and the first working frequency is less than the second working frequency.

When the force is greater than the second threshold, the control unit reduces the working frequency of the motor to control the motor at the first working frequency or the second working frequency.

Optionally, the electric toothbrush further includes a bracket, and the motor is disposed on the bracket.

The pressure responding unit includes a first unit, a second unit, and a third unit. The first unit is disposed on the motor. The second unit and the third unit are disposed on the bracket at intervals, and the second unit and the third unit are oppositely disposed with the first unit.

When the force is less than the first threshold, both the second unit and the third unit are electrically connected with the first unit for conducting.

When the force is greater than the first threshold but less than the second threshold, the first unit and the third unit are disconnected, and the first unit is electrically connected with the second unit for conducting.

When the force is greater than the second threshold, the first unit and the third unit are disconnected, and the first unit and the second unit are disconnected.

Optionally, the motor includes an end surface facing the bracket, and the first unit extends from a middle of the end surface to an edge of the end surface.

The bracket includes a mounting surface facing the motor, the second unit is disposed in a middle of the mounting surface, and the third unit is disposed at an edge of the mounting surface.

Optionally, the electric toothbrush includes a supporting component, the supporting component is disposed on the bracket, the supporting component is attached to the motor, and the supporting component deflects along with the motor.

Optionally, a through hole is defined on the brush handle, the driving shaft penetrates through the through hole, the electric toothbrush further includes a sealing shaft sleeve, and the sealing shaft sleeve is sleeved on the driving shaft and penetrates through the through hole.

Optionally, the sealing shaft sleeve is elastic, and the sealing shaft sleeve deflects and deforms along with the motor.

Optionally, an inner wall of the sealing shaft sleeve includes a convex ring protruding towards the driving shaft; a groove, matching with the convex ring, is defined on the driving shaft, and the convex ring is clamped in the groove.

Optionally, the electric toothbrush further includes a sealing shaft cover, the sealing shaft cover is sleeved on the driving shaft, and the sealing shaft cover is covered on the sealing shaft sleeve.

Optionally, the electric toothbrush further includes a reminding unit, the reminding unit includes at least one of a prompting lamp and a buzzer. When the force is greater than the second threshold, the reminding unit sends a first reminding information; and when the force is greater than the first threshold but less than the second threshold, the reminding unit sends a second reminding information.

The embodiments of the present disclosure further provide a control method of an electric toothbrush. The electric toothbrush includes a brush head and a motor, and the motor is configured to drive the brush head. The control method includes following steps:
obtaining a force of the brush head;
when the force is less than a first threshold, controlling the motor to work at a first working frequency;
when the force is greater than the first threshold but less than a second threshold, increasing the working frequency of the motor to control the motor to work at a second working frequency, where the first threshold is less than the second threshold, and the first working frequency is less than the second working frequency; and
when the force is greater than the second threshold, reducing the working frequency of the motor to control the motor to work at the first working frequency or the second working frequency

In the embodiments of the present disclosure, when the force of the brush head is less than the first threshold, the motor is controlled to work at the first working frequency which frequency is relatively low, so that the motor is in a low vibration frequency state, which prevents toothpaste and foam from splashing, and meanwhile, an effect of saving electric energy is achieved. When the force of the brush head is greater than the first threshold but less than the second threshold, the working frequency of the motor is improved to control the motor at the second working frequency, so that the users can normally brush teeth. The first threshold is less than the second threshold, and the first working frequency is less than the second working frequency. When the force of the brush head is greater than the second threshold, namely, the force of the users putting on the electric toothbrush is too large at the moment, the working frequency of the motor is reduced to control the motor to work at the first working frequency or the second working frequency, which prevents surfaces of gums or teeth from being damaged.

### BRIEF DESCRIPTION OF DRAWINGS

In order to more clearly illustrate technical solutions in embodiments of the present disclosure, drawings required in descriptions of the embodiments are briefly described below. Obviously, the drawings in the following descriptions are merely some embodiments of the present disclosure. For a person skilled in art, other drawings are obtained according to the drawings without creative efforts.

For a more complete understanding of the present disclosure and beneficial effects thereof, the following descriptions are made with reference to the accompanying drawings, wherein same reference numerals refer to same portions in the following descriptions.

FIG. 1 is a structural schematic diagram of an electric toothbrush according to one embodiment of the present disclosure.

FIG. 2 is an exploded schematic diagram of the electric toothbrush shown in FIG. 1.

FIG. 3 is a cross-sectional schematic diagram of the electric toothbrush taken along the line A-A shown in FIG. 1.

FIG. 4 is an enlarged schematic diagram of portion A in the electric toothbrush shown in FIG. 3.

FIG. 5 is an enlarged schematic diagram of portion B of the electric toothbrush shown in FIG. 3.

FIG. 6 is a flowchart of a control method of the electric toothbrush according to one embodiment of the present disclosure.

### DETAILED DESCRIPTION

Technical solutions in embodiments of the present disclosure are clearly and completely described below with reference to accompanying drawings in the embodiments of the present disclosure. Obviously, the described embodiments are only a part of the embodiments of the present disclosure, rather than all of the embodiments. All other embodiments obtained by a person skilled in art based on the embodiments of the present disclosure without creative efforts shall fall within a protection scope of the present disclosure.

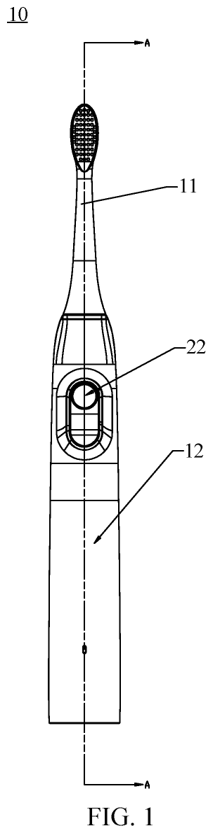

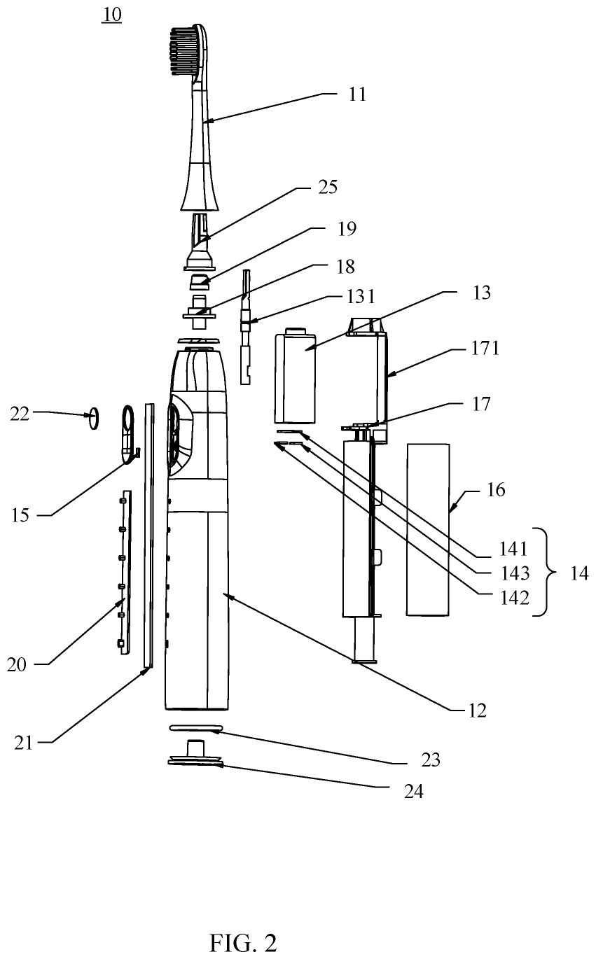

Embodiments of the present disclosure provide an electric toothbrush, as shown in FIG. 1 and FIG. 2. FIG. 1 is a structural schematic diagram of an electric toothbrush according to one embodiment of the present disclosure, and FIG. 2 is an exploded schematic diagram of the electric toothbrush shown in FIG. 1. The electric toothbrush 10 includes a brush head 11, a brush handle 12, a motor 13, a pressure responding unit 14, and a control unit 15. The brush head 11 is configured to brush teeth and oral cavities of users. The brush handle 12 serves as a main supporting housing and is configured to accommodate functional devices such as the motor 13. The motor 13, the pressure responding unit 14, and the control unit 15 are all disposed in the brush handle 12. A driving shaft 131 of the motor 13 penetrates through the brush handle 12, and the driving shaft 131 of the motor 13 is electrically connected with the brush head 11 for driving. The motor 13 drives the brush head 11 to generate high-frequency vibration, so that toothpaste is instantly decomposed into fine foam, and tooth seams are deeply cleaned. At the same time, the vibration of bristles of the brush head 11 promotes blood circulation of the oral cavities, which has a massage effect on gum tissues. The pressure responding unit 14 is configured to acquire a force of the brush head 11. The control unit 15 is electrically connected with the pressure responding unit 14 and the motor 13. The control unit 15 is configured as follows: when the force is less than a first threshold, the control unit 15 controls the motor 13 to work at a first working frequency; when the force is greater than the first threshold but less than a second threshold, the control unit 15 increases the working frequency of the motor 13 to control the motor 13 to work at a second working frequency, the first threshold is less than the second threshold, and the first working frequency is less than the second working frequency; and when the force is greater than the second threshold, the control unit 15 reduces the working frequency of the motor 13 to control the motor 13 to work at the first working frequency or the second working frequency.

Specifically, when the force of the brush head 11 is less than the first threshold, the control unit 15 controls the motor 13 to work at a first working frequency which frequency is relatively low, so that the motor 13 is in a low vibration frequency state, which prevents toothpaste and foam from splashing, and meanwhile, an effect of saving electric energy is achieved. When the force of the brush head 11 is greater than the first threshold but less than the second threshold, the control unit 15 improves the working frequency of the motor 13 to control the motor 13 to work at the second working frequency, so that the users can normally brush teeth. When the force of the brush head 11 is greater than the second threshold, namely, the force of the users putting on the electric toothbrush 10 is too large at the moment, the control unit 15 reduces the working frequency of the motor 13 to control the motor 13 to work at the first working frequency or the second working frequency, which prevents surfaces of gums or teeth from being damaged.

The first threshold and the second threshold are set as needed. For example, the first threshold is any one from 0N to 1N, and the second threshold may further be any one from 2N to 5N. For another example, the first threshold may be any one from 1N to 2N, and the second threshold may further be any one from 3N to 5N. The first working frequency and the second working frequency are set as needed. According to the embodiment, values of the first threshold, the second threshold, the first working frequency, and the second working frequency are not limited.

The electric toothbrush 10 further includes a battery 16. The battery 16 is disposed in the brush handle 12, and the battery 16 charges the motor 13, the pressure responding unit 14, and the control unit 15. The battery 16 may be a non-rechargeable battery 16, or may be a rechargeable battery 16. When the battery 16 is the non-rechargeable battery 16, the battery 16 may be quickly replaced with a stable power supply. When the battery 16 is the rechargeable battery 16, the battery 16 does not need to be replaced, and the rechargeable battery 16 is charged through a respective charging interface, which is convenient for the users to use. Certainly, in some other embodiments, the electric toothbrush 10 does not provide the battery 16, but provides an external power supply line to provide power.

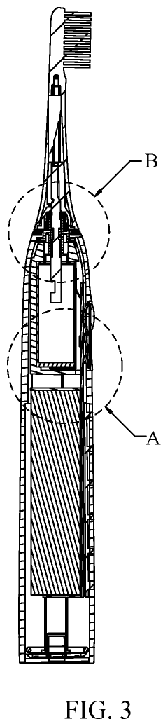

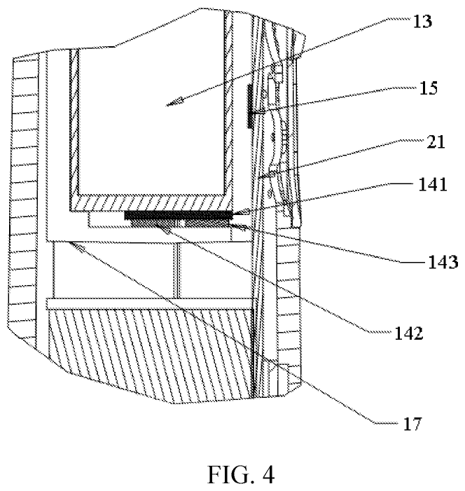

As shown in FIG. 3 and FIG. 4, FIG. 3 is a cross-sectional schematic diagram of the electric toothbrush taken along the line A-A shown in FIG. 1, and FIG. 4 is an enlarged schematic diagram of portion A in the electric toothbrush shown in FIG. 3. The electric toothbrush 10 further includes a bracket 17. The bracket 17 is disposed in the brush handle 12, and the bracket 17 is connected to the brush handle 12. The bracket 17 is fixedly connected to or detachably connected to the brush handle 12. The motor 13 is disposed on the bracket 17, and the bracket 17 is configured as a mounting carrier for the motor 13. The pressure responding unit 14 includes a first unit 141, a second unit 142, and a third unit 143. The first unit 141 is disposed on the motor 13, the second unit 142 and the third unit 143 are disposed on the bracket 17 at intervals, and the second unit 142 and the third unit 143 are oppositely disposed with the first unit 141. When the force is less than the first threshold, both the second unit 142 and the third unit 143 are electrically connected with the first unit 141 for conducting. When the force is greater than the first threshold but less than the second threshold, the first unit 141 and the third unit 143 are disconnected, and the first unit 141 is electrically connected with the second unit 142 for conducting. When the force is greater than the second threshold, the first unit 141 and the third unit 143 are disconnected, and the first unit 141 and the second unit 142 are disconnected. The first unit 141 is fixedly disposed on the motor 13, and the first unit 141 is further detachably disposed on the motor 13. Similarly, the second unit 142 and the third unit 143 are further fixedly disposed on the bracket 17, or the second unit 142 and the third unit 143 are detachably disposed on the bracket 17.

The motor 13 includes an end surface facing the bracket 17, and the first unit 141 extends from a middle of the end surface to an edge of the end surface. The bracket 17 includes a mounting surface facing the motor 13, the second unit 142 is disposed in a middle of the mounting surface, and the third unit 143 is disposed at an edge of the mounting surface. When the brush head 11 is not subjected to an external force, the motor 13 does not deflect, a middle portion of the end surface of the first unit 141 is electrically connected with the second unit 142 for conducting, and an edge portion of the end surface of the first unit 141 is electrically connected with the third unit 143 for conducting. When the brush head 11 is deflected by the external force, the motor 13 which is electrically connected the brush head 11 for driving may regard one side of a bottom of the motor 13 as a supporting point and deflect along with the supporting point, and the first unit 141 goes far away from the second unit 142 and the third unit 143 when deflecting along with the motor 13. When the external force received by the brush head 11 exceeds the first threshold, the first unit 141 and the third unit 143 are disconnected. When the external force received by the brush head 11 exceeds the second threshold, the first unit 141 and the second unit 142 are disconnected, and the control unit 15 controls a vibration frequency of the motor 13 to a set value such as the second frequency to prevent the surfaces of the gums or the teeth from being damaged.

The electric toothbrush 10 further includes a supporting component 171, the supporting component 171 is disposed on the bracket 17, the supporting component 171 is attached to the motor 13, and the supporting component 171 deflects along with the motor 13. The supporting component 171 and the bracket 17 are two independent components, or the supporting component 171 and the bracket 17 are integrally formed components. It should be noted that the supporting component 171 is attached to the motor 13, and the supporting component 171 deflects along with the motor 13, so that characteristics such as elasticity and rigidity of the supporting component 171 are adjusted, and then the first threshold and the second threshold are further adjusted. Optionally, the first threshold and the second threshold may be determined first to select a suitable supporting component 171, such as selecting the supporting component 171 with different materials and/or different shapes, so that the supporting component 171 matches the respective first threshold and the respective second threshold.

The bracket 17 further includes a first limiting component and a second limiting component. The first limiting component and the second limiting component are disposed at two ends of the motor 13. The first limiting component and the second limiting component are connected through the supporting component 171. The first limiting component, the second limiting component, and the supporting component 171 are configured to limit the motor 13. The motor 13 has a certain moving space in the bracket 17, so that the first unit 141 disposed on the motor 13, the second unit 142 disposed on the bracket 17, and the third unit 143 disposed on the bracket 17 are electrically connected for conducting or disconnected. The supporting component 171 is only disposed on one side of the motor 13, that is, the supporting component 171 is not disposed around the motor 13.

It should be noted that, in some embodiments, the bracket further includes a motor bin, the motor bin is configured to accommodate the motor, the second unit and the third unit are disposed in the motor bin, and the second unit and the third unit are opposite to the first unit.

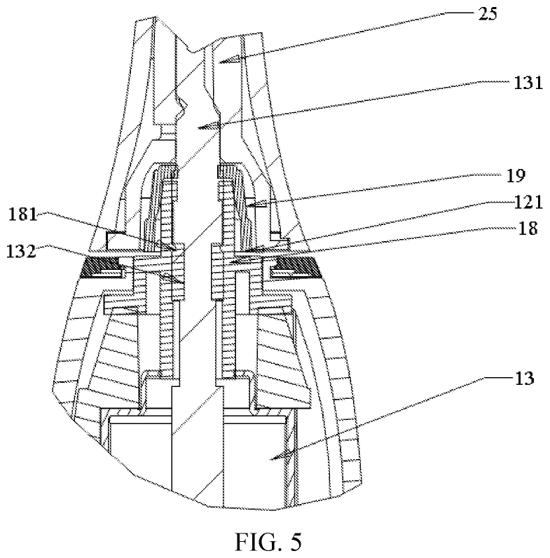

As shown in FIG. 5, FIG. 5 is an enlarged schematic diagram of portion B of the electric toothbrush shown in FIG. 3. A through hole 121 is defined on the brush handle 12, the driving shaft 131 penetrates through the through hole 121 to extend out of the brush handle 12 to connect with the brush head 11. The electric toothbrush 10 further includes a sealing shaft sleeve 18, and the sealing shaft sleeve 18 is sleeved on the driving shaft 131 and penetrates through the through hole 121. The sealing shaft sleeve 18 is detachably connected to the driving shaft 131 of the motor 13, and the sealing shaft sleeve 18 completely blocks the through hole 121 of the brush handle 12 so as to achieve a waterproof effect.

The sealing shaft sleeve 18 is elastic, and the sealing shaft sleeve 18 deflects and deforms along with the motor 13. Characteristics such as elasticity and rigidity of the sealing shaft sleeve 18 are adjusted, and then the first threshold and the second threshold are further adjusted. Optionally, the first threshold and the second threshold may be determined first to select the suitable sealing shaft sleeve 18, such as selecting the sealing shaft sleeve 18 with different materials and/or different shapes, so that the sealing shaft sleeve 18 matches the respective first threshold and the respective second threshold.

It should be noted that the appropriate sealing shaft sleeve 18 and the appropriate supporting component 171 are selected to match the respective first threshold and the respective second threshold. For example, materials of the sealing shaft sleeve 18 and the supporting component 171 may be respectively selected that one is a material with a lower hardness and another one is a material with a higher hardness, so as to match the respective first threshold and the respective second threshold, which is beneficial for selecting a more suitable sealing shaft sleeve 18 and a more suitable supporting component 171.

In order to provide a better waterproof effect, an inner wall of the sealing shaft sleeve 18 includes a convex ring 181 protruding towards the driving shaft 131. A groove 132, matching with the convex ring 181, is defined on the driving shaft 131, and the convex ring 181 is clamped in the groove 132. The convex ring 181 and the groove 132 are clamped to improve the waterproof effect.

Optionally, the electric toothbrush 10 further includes a sealing shaft cover 19, the sealing shaft cover 19 is sleeved on the driving shaft 131, and the sealing shaft cover 19 is covered on the sealing shaft sleeve 18, so that the waterproof effect is further improved.

The electric toothbrush 10 further includes a brush head connecting component 25. The brush head connecting component 25 is disposed in the brush head 11. The brush head 11 is connected with the driving shaft 131 through the brush head connecting component 25 for driving.

Optionally, the electric toothbrush 10 further includes a reminding unit 20, the reminding unit 20 includes at least one of a prompting lamp and a buzzer, and the prompting lamp is an LED lamp or the like. When the force is greater than the second threshold, the reminding unit 20 sends a first reminding information; and when the force is greater than the first threshold but less than the second threshold, the reminding unit 20 sends a second reminding information.

When the force is greater than the first threshold and less than the second threshold, and when the force is greater than the second threshold, the reminding unit 20 sends the same reminding information. For example, a red LED is driven to be turn on and the buzzer is driven to sound. In some other embodiments, when the force is greater than the first threshold and less than the second threshold, and when the force is greater than the second threshold, the reminding unit 20 sends the same reminding information. For example, when the force is greater than the first threshold and less than the second threshold, a green LED lamp is turned on, and a sound of the buzzer is relatively slow. When the force is greater than the second threshold, the red LED is turned on, and the sound of the buzzer is relatively sharp.

Optionally, the reminding unit 20 further sends a reminding signal when the electric toothbrush 10 is powered on. For example, a blue LED lamp is turned on, and the buzzer sounds two times, etc.

It should be understood that the reminding unit 20 in the above embodiment is merely an example, and the reminding unit 20 includes other reminding modes in addition to the above example. The reminding unit 20 is further configured to other reminding modes as required, such as reminding only through the LED lamp, or reminding only through the buzzer. The reminding information is further realized through an electric stimulation. For example, an electric stimulation unit is disposed on an outer surface of the electric toothbrush 10, and when reminding the users, the electric stimulation unit is powered, so as to enhance the electric stimulation to a hand holding the electric toothbrush 10. Different reminding information is given through different intensities and frequencies.

The electric toothbrush 10 further includes a circuit board 21. The control unit 15 is disposed on the circuit board 21. A circuit matching with the control unit 15 is further disposed on the circuit board 21. The control unit 15 is a processor or other chips.

The electric toothbrush 10 further includes a control key 22. The control key 22 is disposed on the brush handle 12. The control key 22 is configured to control the electric toothbrush 10 to power on or off. For example, pressing the control key 22 one time is configured to turn on the motor 13, and then pressing the control key 22 one time again is configured to control the motor 13 to turn off.

Optionally, the electric toothbrush 10 further includes a base 24. The base 24 is disposed at one end, distal from the brush head 12, of the brush handle 12. The base 24 is configured to support the electric toothbrush 10 on a supporting surface, such as a tabletop or countertop. Optionally, a sealing ring 23 is defined between the base 24 and the brush handle 12, so as to improve a waterproof performance of the electric toothbrush 10.

In the embodiments of the present disclosure, the pressure responding unit 14 is configured to match with the control unit 15 to send a warning signal to the users and adjust a vibration mode of the motor 13 when the users brush with a too large force, which effectively protects the teeth and the gums of the users, better protects oral health, improves experience feeling of the users, and improves energy-saving and power-saving performance of the electric toothbrush. When the user powers on the electric toothbrush 10 but does not brush, the vibration mode of the motor 13 is adjusted, which prevents the toothpaste and the foam from splashing, and the experience feeling of the users is improved.

For a better understanding of the solution of the present embodiments, following examples are illustrated.

When the brush head 11 is deflected by the external force, the motor 13 may regard one side of a bottom of the motor 13 as a supporting point and deflect along with the supporting point, and the first unit 141 goes far away from the second unit 142.

When the external force received by the brush head 11 exceeds the second threshold, the first unit 141 and the second unit 142 are disconnected, and the control unit 15 controls the vibration frequency of the motor 13 to the set value to prevent the surfaces of the gums or the teeth from being damaged.

Sides, facing same direction, of the third unit 143 and the second unit 142 are detachably connected to the bracket 17. The third unit 143 and the second unit 142 are electrically connected with the first unit 141 for conducting. The control unit 15 is configured to control the motor 13 to be in the low vibration frequency state, such as the first working frequency, so as to prevent the toothpaste or the foam from splashing.

When the external force received by the brush head 11 exceeds the first threshold but less than the second threshold, the first unit 141 and the third unit 143 are disconnected. The control unit 15 is configured to increase the vibration frequency of the motor 13 to a set value such as the second working frequency, so that the users can normally brush the teeth.

Specifically, when the electric toothbrush 10 is powered off and is not under the force, the pressure responding unit 14 is conducted. That is, the first unit 141 and the second unit 142 are conducted, the first unit 141 and the third unit 143 are conducted, and the motor 13 is not working.

When the electric toothbrush 10 is powered on and is not under the force, the pressure responding unit 14 is turned on. That is, the first unit 141 and the second unit 142 are conducted, the first unit 141 and the third unit 143 are conducted, and the control unit 15 controls the motor 13 to be in the low vibration frequency state such as the first working frequency, and a reminding device sends a reminder such as light and/or sound, which prevents the toothpaste from splashing.

When the electric toothbrush 10 is powered on and is not under the force, and when the external force received by the electric toothbrush 10 is greater than the first threshold, the first unit 141 and the third unit 143 are disconnected. The control unit 15 controls the vibration frequency of the motor 13 to increase to the set value such as the second working frequency, so that the users can normally brush the teeth, and the reminding device sends the reminder such as the light and/or the sound.

When the users rinse their teeth during brushing and pause to brush, the \external force received by the electric toothbrush 10 is less than the first threshold, the first unit 141 and the third unit 143 are conducted. The control unit 15 controls the vibration frequency of the motor 13 to reduce to the low vibration frequency state such as the first working frequency, and the reminding device sends the reminder such as the light and/or the sound, which prevents the foam from splashing.

When the electric toothbrush 10 is powered on and is under the force, and when the external force received by the electric toothbrush 10 is greater than the second threshold, the first unit 141 and the second unit 142 are disconnected. The control unit 15 controls the vibration frequency of the motor 13 to reduce to the low vibration frequency state such as the first working frequency, and the reminding device sends the reminder such as the light and/or the sound to remind the users to decrease the force.

When the users decrease the force, the external force received by the electric toothbrush 10 is greater than the first threshold and less than the second threshold. The first unit 141 and the second unit 142 are conducted. The control unit 15 controls the vibration frequency of the motor 13 to increase to the set value such as the second working frequency, so that the users can normally brush the teeth, and the reminding device sends a light reminder.

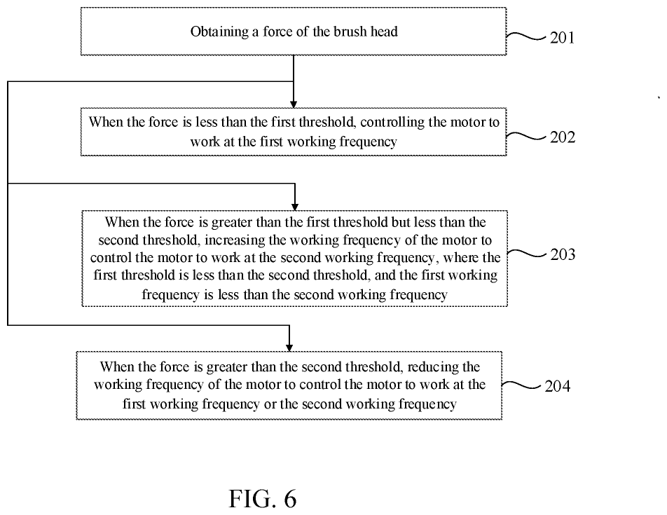

The embodiment of the present disclosure further provides a control method of the electric toothbrush. The electric toothbrush includes a brush head and a motor, and the motor is configured to drive the brush head. A structure of the electric toothbrush refers to the electric toothbrush in the above embodiment, and details are not described herein again. As shown in FIG. 6, FIG. 6 is a flowchart of a control method of the electric toothbrush according to one embodiment of the present disclosure. The control method of the electric toothbrush includes following steps:
201, obtaining a force of the brush head;
202, when the force is less than the first threshold, controlling the motor to work at the first working frequency;
203. when the force is greater than the first threshold but less than the second threshold, increasing the working frequency of the motor to control the motor to work at the second working frequency, where the first threshold is less than the second threshold, and the first working frequency is less than the second working frequency; and
204. when the force is greater than the second threshold, reducing the working frequency of the motor to control the motor to work at the first working frequency or the second working frequency.

When the force received by the brush head is less than the first threshold, the motor is controlled to work at the first working frequency which frequency is relatively low, so that the motor is in the low vibration frequency state, which prevents the toothpaste and the foam from splashing. When the force received the brush head is greater than the first threshold but less than the second threshold, the working frequency of the motor is improved to control the motor to work at the second working frequency, so that the users can normally brush the teeth. When the force received by the brush head is greater than the second threshold, namely, the force of the users putting on the electric toothbrush is too large at the moment, the control unit reduces the working frequency of the motor to control the motor to work at the first working frequency or the second working frequency, which prevents the surfaces of the gums or the teeth from being damaged.

Optionally, the method further includes that when the electric toothbrush is powered on, controlling the motor to work at the first working frequency. When the electric toothbrush is powered on, controlling the motor to work at the first frequency having a low frequency to prevent the toothpaste from splashing.

Optionally, after increasing the working frequency of the motor to control the motor work at the second working frequency, or after reducing the working frequency of the motor to control the motor operate at the second working frequency, the method further includes following.

When the force is less than the first threshold, reducing the working frequency of the motor to control the motor to work at the first working frequency. After the motor works at the second working frequency, if the force is less than the first threshold, it is indicated that the users the users rinse their teeth or do other things during brushing and pause to brush. At this time, if the motor continues to work at the second working frequency, the toothpaste and the foam may splash. Therefore, at this time, the working frequency of the motor is reduced to control the motor to work at the first working frequency, which effectively prevents a possibility of splashing of the toothpaste and the foam.

Optionally, a step of when the force is greater than the second threshold, reducing the working frequency of the motor to control the motor to work at the second working frequency includes following.

When the force is greater than the second threshold, sending a first reminding information, and reducing the working frequency of the motor to drive the motor to work at the second working frequency.

When the force is greater than the second threshold, reducing the working frequency of the motor, and sending the first reminding information, reminding the users that the current force is too large, which easily damages the surfaces of the gums or the teeth. The users may reduce the force or pause and wait for the motor to reduce the frequency to prevent the surfaces of the gums or the teeth from being damaged. The first reminding information is one or more of sound, light, electrical stimulation, etc. For example, a buzzer emits the short sound, a loudspeaker emits a voice to stop brushing, a red LED lamp flashes, an electrical stimulation unit disposed on an outer surface of the electric toothbrush provides an electrical stimulation signal, etc.

Optionally, a step when the force is greater than the first threshold but less than the second threshold, increasing the working frequency of the motor to make the motor operate at the second operating frequency includes following.

When the force is greater than the first threshold but less than the second threshold, sending a second reminding information, and increasing the working frequency of the motor to control the motor to work at the second working frequency.

When the force is greater than the first threshold but less than the second threshold, not only increasing the working frequency of the motor, but also sending the second reminding information to remind the users that the motor needs to increase the frequency to brush the teeth, so that the users can normally brush the teeth. The second reminding information is one or more of the sound, the light, the electrical stimulation, etc. For example, the buzzer emits the slow sound, the loudspeaker emits a voice to start brushing, the green LED lamp flashes, the electrical stimulation unit disposed on the outer surface of the electric toothbrush provides the electrical stimulation signal, etc.

In the above embodiments, a description of each embodiment has its own emphasis. For portions that are not described in detail in a certain embodiment, reference is made to the relevant descriptions of other embodiments.

The electric toothbrush and the control method thereof provided in the embodiments of the present disclosure are described in detail above. Principles and implementations of the present disclosure are set forth herein with reference to specific examples. The descriptions of the above embodiments are merely configured to help understand methods of the present disclosure and core ideas thereof. Meanwhile, for a person skilled in art, according to the ideas of the present disclosure, there is a change in a specific implementation mode and an application range. In summary, contents of the present disclosure should not be construed as limiting the present disclosure.

What is claimed is:

1. An electric toothbrush, comprising:
a brush head;
a brush handle;
a motor;
a pressure responding unit; and
a control unit;
wherein the motor is disposed in the brush handle, a driving shaft of the motor penetrates through the brush handle and is connected with the brush head for driving the brush head;
the pressure responding unit is disposed in the brush handle, the pressure responding unit is configured to acquire a force of the brush head;
the control unit is disposed in the brush handle, the control unit is electrically connected with the pressure responding unit and the motor; the control unit is configured as follows:
when the force is less than a first threshold, the control unit controls the motor to work at a first working frequency;
when the force is greater than the first threshold but less than a second threshold, the control unit increases a working frequency of the motor to control the motor to work at a second working frequency, the first threshold is less than the second threshold, and the first working frequency is less than the second working frequency; and
when the force is greater than the second threshold, the control unit reduces the working frequency of the motor to control the motor at the first working frequency or the second working frequency.

2. The electric toothbrush according to claim 1, wherein the electric toothbrush further comprises a bracket, the motor is disposed on the bracket;
the pressure responding unit comprises a first unit, a second unit, and a third unit; wherein the first unit is disposed on the motor, the second unit and the third unit are disposed on the bracket at intervals, the second unit and the third unit are oppositely disposed with the first unit;
when the force is less than the first threshold, both the second unit and the third unit are electrically connected with the first unit for conducting;
when the force is greater than the first threshold but less than the second threshold, the first unit and the third unit are disconnected, the first unit is electrically connected with the second unit for conducting; and
when the force is greater than the second threshold, the first unit and the third unit are disconnected, and the first unit and the second unit are disconnected.

3. The electric toothbrush according to claim 2, wherein the motor comprises an end surface facing the bracket, the first unit extends from a middle of the end surface to an edge of the end surface;
the bracket comprises a mounting surface facing the motor, the second unit is disposed in a middle of the mounting surface, and the third unit is disposed at an edge of the mounting surface.

4. The electric toothbrush according to claim 3, wherein the electric toothbrush comprises a supporting component, the supporting component is disposed on the bracket, the supporting component is attached to the motor, and the supporting component deflects along with the motor.

5. The electric toothbrush according to claim 1, wherein a through hole is defined on the brush handle, the driving shaft penetrates through the through hole, the electric toothbrush further comprises a sealing shaft sleeve, and the sealing shaft sleeve is sleeved on the driving shaft and penetrates through the through hole.

6. The electric toothbrush according to claim 5, wherein the sealing shaft sleeve is elastic, and the sealing shaft sleeve deflects and deforms along with the motor.

7. The electric toothbrush according to claim 5, wherein an inner wall of the sealing shaft sleeve comprises a convex ring protruding towards the driving shaft; a groove, matching with the convex ring, is defined on the driving shaft, and the convex ring is clamped in the groove.

8. The electric toothbrush according to claim 5, wherein the electric toothbrush further comprises a sealing shaft cover, the sealing shaft cover is sleeved on the driving shaft, and the sealing shaft cover is covered on the sealing shaft sleeve.

9. The electric toothbrush according to claim 1, wherein the electric toothbrush further comprises a reminding unit, the reminding unit comprises at least one of a prompting lamp and a buzzer; when the force is greater than the second threshold, the reminding unit sends a first reminding information; and when the force is greater than the first threshold but less than the second threshold, the reminding unit sends a second reminding information.

10. A control method of an electric toothbrush, wherein the electric toothbrush comprises a brush head and a motor, the motor is configured to drive the brush head, and the control method comprises following steps:
obtaining a force of the brush head;
when the force is less than a first threshold, controlling the motor to work at a first working frequency;
when the force is greater than the first threshold but less than a second threshold, increasing the working frequency of the motor to control the motor to work at a second working frequency, where the first threshold is less than the second threshold, and the first working frequency is less than the second working frequency; and
when the force is greater than the second threshold, reducing the working frequency of the motor to control the motor to work at the first working frequency or the second working frequency.
